(19) United States
(12) Patent Application Publication
(10) Pub. No.: US 2008/0164188 A1
(43) Pub. Date: Jul. 10, 2008

(54) FUEL FILTER

(76) Inventors: Hans Jensen, West Bloomfield, MI (US); Torsten Lika, Stuttgart (DE); Jurgen Stachl, Walled Lake, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/960,314

(22) Filed: Dec. 19, 2007

(30) Foreign Application Priority Data
Dec. 20, 2006 (DE) DE102006060127.0

(51) Int. Cl. B01D 35/00

(52) U.S. Cl. 210/120; 210/436; 210/455; 210/454

(57) ABSTRACT

A fuel filter for an internal combustion engine of a motor vehicle, comprising
a divisible housing having a fuel inlet opening and an outflow opening,
a replaceable ring filter element (3) mounted in the housing so that flow can pass through it radially from the outside to the inside, having an end disk on one end, namely a first end disk (13) and a second end disk,
an alignment of the longitudinal axis of the ring filter element (3) that is upright during filter operation,
an outflow channel (5) which leads from the bottom to the top out of the fuel outflow opening in the radial interior of the ring filter element (3), carrying filtered fuel away in a tube (4),
a centrally arranged vent channel (6) that leads outward from the bottom and is closed at the top, with a throttle opening (7) in the upper closure, whereby this throttle opening (7) opens into the clean space or the crude space of the filter,
   should be designed so that the internal combustion engine cannot be operated when the ring filter insert (3) is missing.

To this end, such a fuel filter is characterized by the following features:
the outflow channel (5) carrying filtered fuel away communicates with the clean space upstream from this valve (8) exclusively through this valve (8),
the valve (8) is opened when a ring filter element (3) is present and is closed when the ring filter element (3) is absent,
the valve condition in the open or closed position is determined exclusively by the presence or absence of the ring filter element (3) as a valve actuating element.

The invention relates to a fuel filter according to the preamble of Patent Claim 1.

Such a filter is known from DE 195 19 352 C2, for example.

DE 103 29 199 A1 describes a fuel filter having a main-stream filter insert and a side-stream filter insert, both of which are replaceable. A valve which allows a side-stream to become a main-stream when a side-stream filter is present and automatically closes this side-stream when there is no side-stream filter insert is provided on the clean end inside the side-stream filter insert. Due to such a valve arrangement and function, with the aforementioned main-stream/side-stream oil filter, adequate operational function of the filter device is ensured even in the absence of a side-stream filter. When there is no filter insert, a closed valve is necessary for the following reasons, in particular when the oil that is filtered in the side-stream filter can flow into a pressureless space, which may be the crankcase of the internal combustion engine. In this case the side-stream filter insert has an extremely high flow resistance so that the oil, which is supplied from a common supply line to the main-stream and side-stream filter inserts of the filter, does not experience an excessively great pressure drop. For example, a centrifuge used as a side-stream filter has an especially high flow resistance. The valve used with the oil filter serves exclusively to ensure engine operation even in the event the respective filter insert has inadvertently been omitted.

The present invention relates to the problem with a generic fuel filter that operation of the internal combustion engine should not be possible when the fuel filter is not present in the fuel supply line.

This problem is solved by designing a generic fuel filter according to the characterizing features of Patent Claim 1.

Advantageous and expedient embodiments are the subject matter of the dependent claims.

This invention is based on the general idea of providing a valve in the clean-side outflow channel of the filter such that when the filter insert is missing, the valve is automatically closed and when the filter insert is present the valve is automatically opened. This automatic valve operation is accomplished by the filter element as the actuating element, i.e., when the filter insert has been inserted, it opens the valve whereas this open position is canceled when the filter insert is removed.

In an expedient embodiment of the invention, a spring is provided on the valve to ensure a closed position of the valve and open the valve against the force of the spring when the filter insert is inserted.

Advantageous exemplary embodiments to be explained in greater detail below are illustrated in the drawing.

The drawings show in a longitudinal section the upper part of a fuel filter of an internal combustion engine, namely

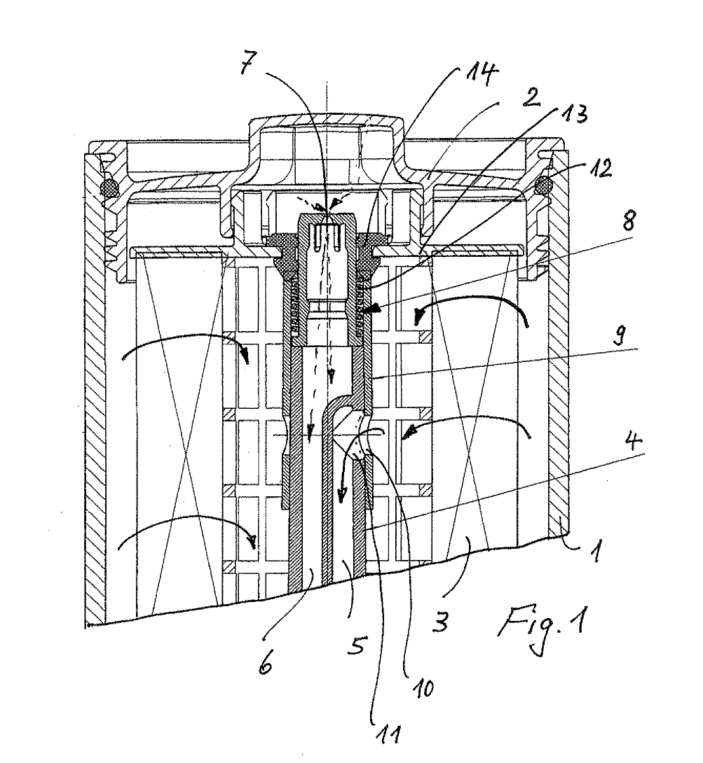

FIG. 1 shows a first embodiment,

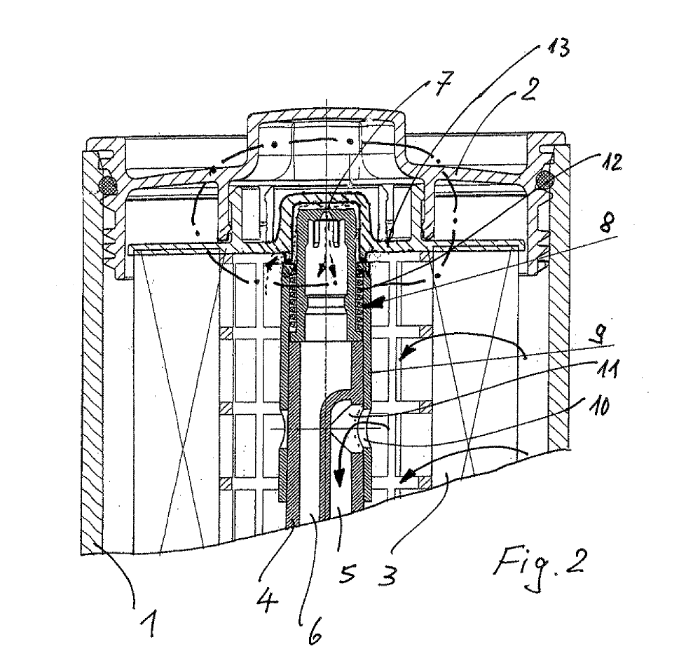

FIG. 2 shows a second embodiment.

### FIG. 1

A ring filter element 3 is replaceably mounted in a bottom housing part 1, which is sealed at the top with a cover 2. The flow passes through this ring filter element 3 from the outside radially to the inside radially, i.e., the crude side is on the outside radially and the clean space of the filter is on the inside radially. The flow through the ring filter element 3 described above is indicated by flow arrows.

The fuel inlet and outlet lines are located in the bottom part of the housing bottom part 1 (not shown).

Filtered fuel is removed at the clean end of the ring filter element 3 through a tube 4 which extends from underneath into the clean space and communicates with the fuel outlet. This tube 4 is mounted on the filter housing, so that when the ring filter element 3 is replaced, it remains inside the bottom part of the housing. The tube 4 has two separate flow channels, namely an outflow channel 5 for filtered fuel and a vent channel 6. The vent channel 6 is connected to the crude side of the filter at the upper end of the tube 4 through a throttle bore 7. The other end of this vent channel 6 leads back to a fuel collecting space, i.e., in particular back into the fuel tank. Such vent channels and their function are known with fuel filters.

The flow through the outflow channel 5 is controlled by a valve 8. This valve 8 consists essentially of two concentric tube sections, one of which is formed by the stationary tube 4, while the other section, which surrounds the former section concentrically, is formed by a sleeve 9 that is displaceable longitudinally on the tube 4. In the valve-tube section of the tube 4 on the one hand and in the sleeve 9 on the other hand, at least one radial bore is provided in each, namely a radial bore 10 in the sleeve 9 and a radial bore 11 in the tube 4. Depending on the displacement position of the sleeve 9 with respect to the tube 4, the two radial bores 10 and 11 form a flowthrough opening into the outflow channel 5 or these openings 10, 11 are displaced toward one another, so there is a closing function of the valve 8, i.e., a condition in which filtered fuel cannot enter the outflow channel 9.

The sleeve 9 is supported in a spring-loaded fashion in the tube 4. The spring loading is accomplished by a helical spring 12, which is supported on opposing abutments of the tube 4 on the one hand and on the sleeve 9 on the other hand. In the absence of a ring filter element 3, the helical spring 12 expands in length, so that the valve 8 has a closing function. When the ring filter element 3 is present, the helical spring 12 is put under tension in that a tension force is exerted on the helical spring 12 by the ring filter element 3 via its end disk 13. This force is exerted by the fact that the end disk 13 acts directly on the abutment of the helical spring 12 on the sleeve end via a sealing ring 14 provided on its radial inside circumference.

With the filter housing, which is shown in a closed state in the diagram, the valve 8 is opened. When the filter cover 2 is opened for the purpose of replacing the ring filter element 3, the abutment of the helical spring 12 on the sleeve end is relieved of force, so that the helical spring 12 displaces the sleeve 9 into a valve-closing position. When a used ring filter element 3 is replaced by a new one, the valve 8 opens in exactly the opposite manner in closing the filter housing.

### FIG. 2

The design of the fuel filter according to FIG. 2 differs from that according to FIG. 1 only in the type of ventilation within the filter. Whereas the ventilation is accomplished from the crude side of the filter in the embodiment according to FIG. 1, the ventilation is provided from the clean side in the embodiment according to FIG. 2. The design of the fuel filter according to FIG. 2 therefore differs only from that according to FIG. 1 in the area outlined with a dash-dot line in FIG. 2. The essential difference is that the end disk 13 of the ring filter element 3 in the embodiment according to FIG. 2 is designed to be closed, whereas in the embodiment according to FIG. 1, this end disk 13 is in the form of a ring disk that is open at the center. The different vent flows occurring with the two different filter embodiments are illustrated with flow arrows in the two figures.

With the ring filter element 3, the area of the first end disk 13 bordering its interior space serves as the actuating device for the valve 8. A ring collar 15 is provided on the side of the end disk facing the clean side of the ring filter element 3 as an actuating element. This ring collar 15 contacts with its end face the displaceable tube section of the valve 8 designed as a sleeve 9. Within the ring collar 15 at least one through-channel 16 is provided and may open axially into the contact face. This through-channel 16 allows the vent air to flow through, with an otherwise smooth, flat, end face of the outer tube section 9 and a ring collar 15 that is in contact with this end face. The opening of this through-channel 16 may be designed as an additional throttle opening. In this way, double throttling can be achieved in first and second throttle openings.

The throttle opening 7 in the vent channel 6 should be as open as possible, with the filter situated upright to allow optimum venting to be achieved. The throttle opening 7 is advantageously situated above the upper end disk of the ring filter element 3 according to the diagram in FIG. 2. To be able to implement this with venting on the clean side of the filter, the first end disk 13 there must have a bulge 17 in its central area directed outward starting from the interior of the ring filter element 3.

All the features depicted in the specification and in the following claims may be essential to the present invention either individually or in any combination with one another in any form.

1. A fuel filter for an internal combustion engine of a motor vehicle, comprising
a divisible housing having a fuel inlet opening and an outflow opening,
a replaceable ring filter element (3) mounted in the housing so that the flow can pass through it radially from the outside to the inside, having an end disk on one end, namely a first end disk (13) and a second end disk,
an alignment of the longitudinal axis of the ring filter element (3) that is upright during filter operation,
an outflow channel (5) which leads from the bottom to the top out of the fuel outflow opening in the radial interior of the ring filter element (3), carrying filtered fuel away in a tube (4),
a centrally arranged vent channel (6) that leads outward from the bottom and is closed at the top, with a throttle opening (7) in the upper closure, whereby this throttle opening (7) opens into the clean space or the crude space of the filter,
characterized by the features
the outflow channel (5) carrying filtered fuel away communicates with the clean space upstream from this valve (8) exclusively through this valve (8),
the valve (8) is opened when a ring filter element (3) is present and is closed when the ring filter element (3) is absent,
the valve condition in the open or closed position is determined exclusively by the presence or absence of the ring filter element (3) as a valve actuating element.

2-11. (canceled)
